(19) United States
(12) Patent Application Publication
(10) Pub. No.: US 2008/0081569 A1
(43) Pub. Date: Apr. 3, 2008

(54) Mobile-phone

(75) Inventor: Mitsuji Shiono, Ome-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/698,372

(22) Filed: Jan. 26, 2007

(30) Foreign Application Priority Data
Sep. 29, 2006 (JP) 2006-269971

(51) Int. Cl. H04B 1/034

(52) U.S. Cl. 455/95

(57) ABSTRACT

A mobile-phone includes a receiving unit configured to receive a television broadcasting signal, a display unit configured to display a television picture based on the television broadcasting signal and to display incoming call information showing a content of an incoming call, a sound output unit configured to output a television sound based on the television broadcasting signal and to output a ringtone, and a control unit configured to control the display unit to display the incoming call information at a position not to overlap with an area displaying the television picture, and to control the sound output unit to restrict the output of the ringtone, if the control unit detects a incoming call signal during displaying the television picture.

### CROSS-REFERENCE TO RELATED APPLICATIONS

This application is based upon and claims the benefit of priority from prior Japanese Patent Application No. 2006-269971, filed Sep. 29, 2006, the entire contents of which are incorporated herein by reference.

### BACKGROUND OF THE INVENTION

1. Field of the Invention

The present invention relates to a mobile-phone with a television viewing function.

2. Description of the Related Art

These days, a mobile-phone mounted with a receiving function of terrestrial digital broadcasting has been developed to be introduced into the markets. From the point of view of improvement of user's convenience, the mobile-phone values and devises many ideas for processing which is performed when a voice incoming call signal or a mail receiving signal is detected in the mobile-phone receiving and viewing the terrestrial digital broadcasting. A technique related to a mobile-phone automatically shifting into a speech mode when an incoming call is arrived during television viewing is disclosed by Jpn. Pat. Appln. KOKAI Publication No. 2005-109819. When an incoming call is arrived in receiving television broadcasting, and also when a main body opening switch detects that the cover of the mobile-phone has been opened, the technique suspends a display of a television screen to shift into the speech mode.

However, an incoming call arrival (or data reception of mail, etc.) occurring in timing that a user does not expect, uniformly performing the foregoing processing into practice in the case of the incoming call arrival during the television viewing possibly misses a crucial moment of an information program, a sports program, etc., against user's will.

As for the form of the television viewing, other than outputting both sounds and videos, some forms thereof outputs only sounds and does not output videos; however, the Jpn. Pat. Appln. KOKAI Publication 2005-109819 does not disclose a technique to change the processing in receiving the incoming call in accordance with the difference in form of the television viewing.

### BRIEF SUMMARY OF THE INVENTION

According to first aspect of the invention, there is provided a mobile-phone comprising: a receiving unit configured to receive a television broadcasting signal; a display unit configured to display a television picture based on the television broadcasting signal and to display incoming call information showing a content of an incoming call; a sound output unit configured to output a television sound based on the television broadcasting signal and to output a ringtone; and a control unit configured to control the display unit to display the incoming call information at a position not to overlap with an area displaying the television picture, and to control the sound output unit to restrict the output of the ringtone, if the control unit detects a incoming call signal during displaying the television picture.

According to second aspect of the invention, there is provided a mobile-phone comprising: a receiving unit configured to receive a television broadcasting signal; a display unit configured to display a television sound based on the television broadcasting signal and to display received mail information; a sound output unit configured to output a television sound based on the television broadcasting signal and to output a mail receiving sound; and a control unit configured to control the display unit to display the received mail information at a position not overlapping with an area displaying the television picture and to control the sound output unit to restrict the output of the mail receiving sound if the control unit detects a mail receiving signal during displaying the television picture.

According to third aspect of the invention, there is provided a mobile-phone comprising: a receiving unit configured to receive a broadcasting signal; a display unit configured to display a picture based on the broadcasting signal and to display an incoming call information showing a content of an incoming call; a sound output unit configured to output a sound based on the broadcasting signal and to output a ringtone; and a control unit configured to control the display unit to display the incoming call information at a position not to overlap with an area displaying the picture, and to control the sound output unit to restrict the output of the ringtone, if the control unit detects a incoming call signal during displaying the picture.

### BRIEF DESCRIPTION OF THE SEVERAL VIEWS OF THE DRAWING

FIG. 1 is a block diagram depicting a mobile-phone according to one embodiment of the invention;

FIG. 2A, FIG. 2B, FIG. 2C and FIG. 2D are exemplary views respectively depicting examples of setting tables stored in a storage unit 6 of the mobile-phone of FIG. 1;

FIG. 3A, FIG. 3B, FIG. 3C and FIG. 3D are exemplary views respectively depicting examples of displays on an LCD 5 of the mobile-phone of FIG. 1; and

FIG. 4 is a flowchart depicting an incoming call processing procedure during television viewing in the mobile-phone of FIG. 1.

### DETAILED DESCRIPTION OF THE INVENTION

Hereinafter, embodiments of the present invention will be described with reference to the drawings.

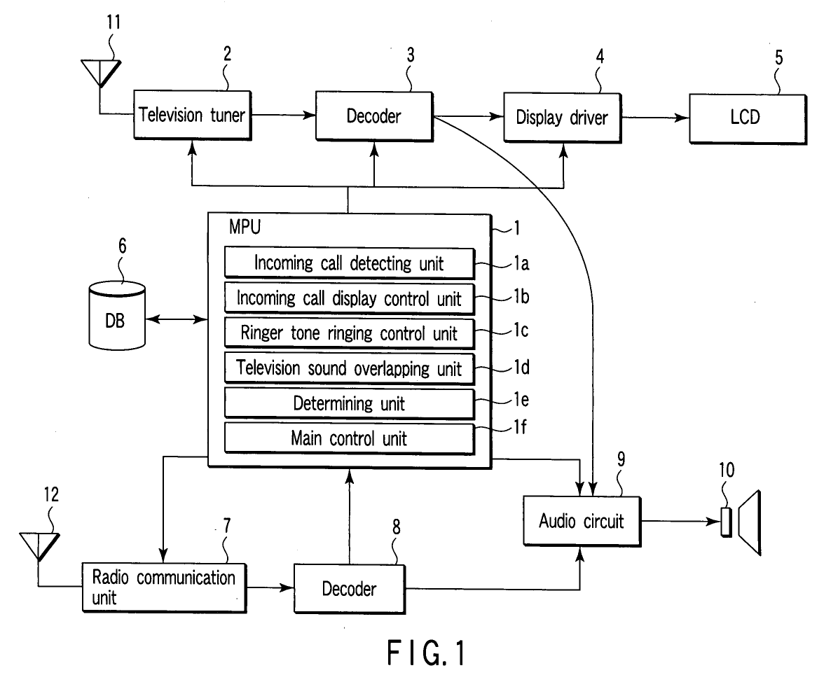

As shown in FIG. 1, the mobile-phone according to the embodiment includes a control unit 1, a television tuner 2 connected to the control unit 1, a decoder 3 connected to the control unit 1 and the television tuner 2, a display driver 4 connected to the control unit 1 and the decoder 3, a liquid crystal display (LCD) 5 connected to the display driver 4, a storage unit 6 connected to the control unit 1, a radio communication unit 7 connected to the control unit 1, a decoder 8 connected to the control unit 1 and the radio communication unit 7, an audio circuit 9 connected to the control unit 1, the decoder 3 and the decoder 8, a loud-speaker 10 connected to the audio circuit 9, antenna 11 connected to the television tuner 2, and antenna 12 connected to the radio communication unit 7. The control unit 1 is, for instance, a micro processing unit (MPU), and has an incoming call detecting unit 1a, an incoming call display control unit 1b, a ringtone ringing control unit 1c, a television sound overlapping unit 1d, a determining unit 1e, and a main control unit 1f.

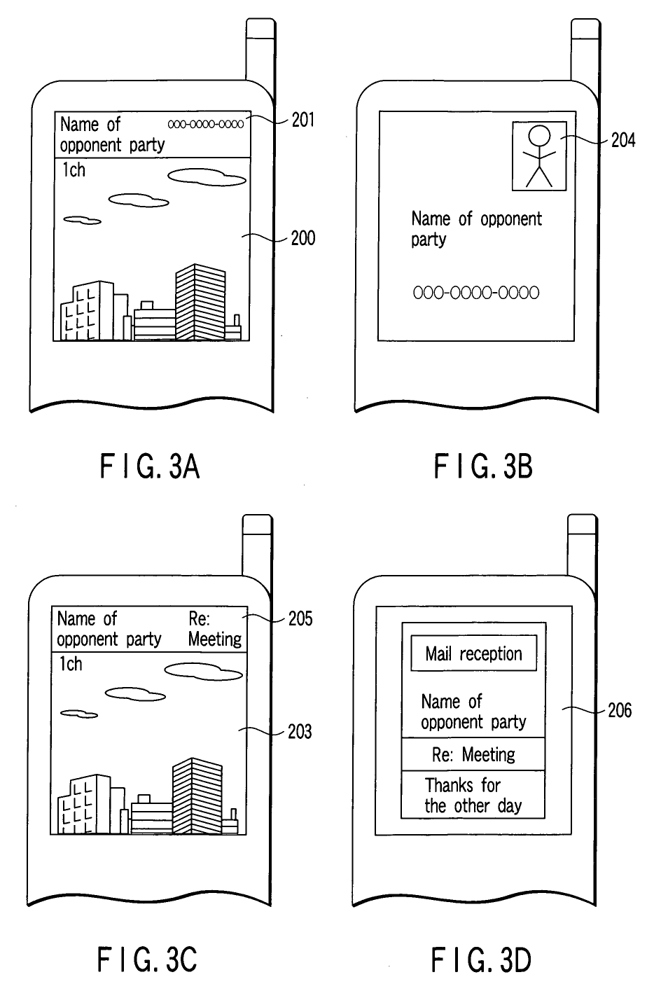

The detecting unit la detects whether or not a voice incoming call signal is received, or a mail receiving signal (signal of the fact of presence of mail addressed to the mobile-phone) is received. The incoming call display control unit 1b displays the fact of receiving the incoming call onto the LCD 5, as shown in FIG. 3A or FIG. 3B, when the incoming call detecting unit la detects the reception of the voice incoming call signal. The incoming call display control unit 1b displays the fact of the reception of the mail onto the LCD 5, as shown in FIG. 3C or FIG. 3D, when the incoming call detecting unit 1a detects the reception of the mail receiving signal.

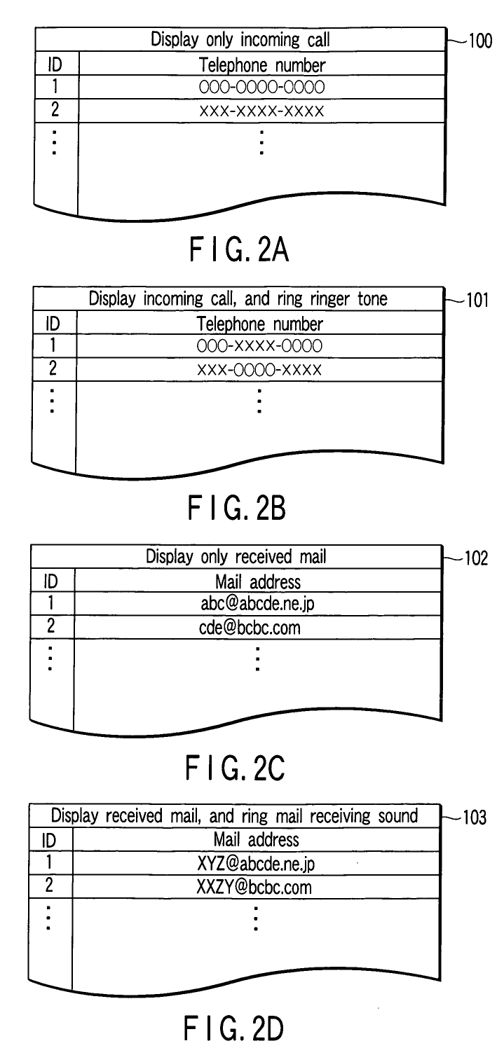

The ringtone ringing control unit 1c rings a ringtone associated with a telephone number including the corresponding voice incoming call signal from the loud-speaker 10 when the incoming call detecting unit 1a detects the reception of the voice incoming call signal. That is, as mentioned later, if the telephone number included in the voice incoming call signal is one which has been registered in a setting table 100 of the storage unit 6 shown in FIG. 2A, the incoming call display control unit 1b performs an incoming call display, but the ringtone ringing control unit 1c does not ring the ringtone. On the other hand, if the telephone number included in the voice incoming call signal is one which has been registered in a setting table 101 of the storage unit 6 shown in FIG. 2B, the ringing control unit 1c rings the ringtone as well as the incoming display control unit 1b performs the incoming call display. When the incoming call detecting unit 1a detects the reception of the mail receiving signal, the ringtone ringing control unit 1c rings the mail receiving sound, associated with the address of the sender of the mail, from the loud-speaker 10. That is to say, as described below, if the mail address of the sender included in the mail receiving signal is one registered in a setting table 102 of the storage unit 6 shown in FIG. 2C, the incoming call display control unit 1b performs a mail reception display, but the ringtone ringing control unit 1c does not ring the mail receiving sound. In contrast, if the mail address of the sender included in the mail receiving signal is one registered in a setting table 103 of the storage unit 6 shown in FIG. 2D, the ringing control unit 1c rings the mail receiving sound as well as the incoming call display control unit 1b performs the mail reception display.

The determining unit 1e determines whether or not a video is output to the LCD 5 during television viewing, if the video is not output to the LCD 5, it outputs a determination result of the fact that the television viewing is only for sounds. It is acceptable for determining whether the video is outputted or not on the basis of the fact, for instance, whether or not a housing state is in a state where the LCD 5 cannot be watched from the outside of the mobile-pone (for example, state where mobile-phone is folded if it is twofold mobile-phone). It is also allowable to determine its state on the basis of the fact whether or not the mobile-phone has been displaying other application (mailer, browser, telephone book editor, or function setting screen) although it has started a television application.

In the mobile-phone shown in FIG. 1, the television tuner 2 receives terrestrial digital broadcasting through an antenna 11 to demodulate modulated signals. The encoded video data and audio data obtained by this demodulation are given to the decoder 3. The decoder 3 decodes the video data and audio data, and the LCD 5 drive-controlled by the display driver 4 displays the video. The audio is output from the loud-speaker 10.

The main control unit if controls the whole of the aforementioned processing.

The radio communication unit 7 receives the voice incoming call signal and the mail receiving signal through the antenna 12 to demodulate the modulated signals. The encoded data of voice data and of electronic mail obtained through this demodulation are supplied to the decoder 8. The decoder 8 decodes the encoded data to output data of the voice or the electronic mail. The voice is performed a prescribed process through the audio circuit 9 then output from the loud-speaker 10. The data of the electronic mail is appropriately displayed on the LCD 5 drive-controlled by the display driver 4 under the control by the main control unit 1f. At this moment, the control unit 1 performs control as follows.

That is to say, when detecting the voice incoming call signal or the mail receiving signal by the incoming call detecting unit 1a during the television viewing under the control from the main control unit 1f, the control unit 1 makes the incoming call display control unit 1b perform the incoming call display or mail receiving display shown in FIG. 3A, FIG. 3B, FIG. 3C or FIG. 3D so as not to overlap the television viewing screen on the LCD 5. At the same time, the control unit 1 makes the ringtone ringing control unit 1c control so as to adaptively suppress the ringing of the ringtone or the mail receiving tone from the loud-speaker 10.

To ringing-control of the ringtone, it is acceptable to register telephone numbers, which perform incoming call displays and do not ring the ringtones, in the setting table 100 in advance as shown in FIG. 2A, and it is also allowable to register the telephone numbers which ring the ringtones as well as perform the incoming call displays in the setting table 101 in advance as shown in FIG. 2B. When the incoming call detecting unit 1a detects the incoming call, the control unit 1 makes the ringtone ringing control unit 1c refer to the setting tables 100 or 101 stored in the storage unit 6 to control the ringtones on the basis of the information registered therein. More specifically, the setting table 100 in FIG. 2A stores IDs and telephone numbers of the mobile-phones, which perform their incoming call displays as shown in FIG. 3A or FIG. 3B but do not ring their ringtones, by associating with one another. On the other hand, the setting table 101 in FIG. 2B stores IDs and telephone numbers of the mobile-phones, which both perform their incoming call displays as shown in FIG. 3A or FIG. 3B and ring their ringtones, by associating with one another. These IDs are also used for a telephone book (not shown) and enable extracting necessary information by using IDs as keys from the telephone book if necessary.

In contrast, it is acceptable to register mail addresses performing the mail receiving displays but not ringing the mail receiving sounds in the setting table 102 in advance as shown in FIG. 2C. And also, it is acceptable to register the mail addresses both performing the mail receiving displays and ringing the mail receiving sounds in the setting table 103 in advance as shown in FIG. 2D. In the control unit 1, when the incoming call detecting unit la detects the reception of the mail receiving signal, the ringtone ringing control unit 1c refers to the setting tables 102 and 103 stored in the storage unit 6 to control the mail receiving sound on the basis of the information registered therein. More specifically, the setting table 102 in FIG. 2C stores IDs and mail addresses of mobile-phones, which perform their mail receiving displays as shown in FIG. 3C or FIG. 3D but do not ring their mail receiving sound, by associating with one another. On the other hand, the setting table 103 in FIG. 2D stores IDs and mail addresses of mobile-phones, which both perform their mail receiving displays as shown in FIG. 3C or FIG. 3D and ring their mail receiving sounds, by associating with one another. These IDs are also used for the telephone book (not shown) and enable extracting necessary information by using them as keys from the telephone book if necessary.

The ringtone ringing control unit 1c of the control unit 1 refers to the setting tables 100 or 101, and 102 or 103, and when detecting the reception of the voice incoming call signal or the mail receiving signal, determines whether the sender is a partner to whom only the incoming call display (or mail receiving display) should be performed, or a partner to whom both the incoming call display (or mail receiving display) and the ringing of the ringtone (or mail receiving sound) should be performed to control the ringing of the ringtone.

Further, to perform the television viewing through the mobile-phone it may view both videos and sounds, or only the sounds; however, when the determining unit 1e determines that the mobile-phone currently outputs only sounds in the television viewing, the control unit 1 rings the ringtone by the ringtone ringing control unit 1c. The control unit 1 may output the television sounds even in speech by means of the television sound overlapping unit id by overlapping the television sounds to the partner's voice during speech.

In an example shown in FIG. 3A, an incoming call display area 201 is provided at an upper part of a television viewing screen 200, then, the incoming call display control unit 1b displays a name of a sender's name (name associated with telephone number registered in not shown telephone book) and a telephone number (only name may be displayed). In an example shown in FIG. 3B, in addition to the display of the name and telephone number (only name may be displayed) of the sender, an area 204 displays a photograph of the sender (image information associated with telephone number registered in not shown telephone book). In an example shown in FIG. 3C, a mail receiving display area 205 disposed at un upper part of a television viewing screen 203 displays a name of a mail sender (name associated with mail address registered in not shown telephone book), and a subject title (subject title of received mail). In an example in FIG. 3D, an area 206 displays the fact of receiving mail and the name (name associated with mail address registered in not shown telephone book), a subject title (subject title of received mail), and a body text (first several lines including body text of received mail). These samples are only display examples on the LCD 5, and display forms are not limited to these examples.

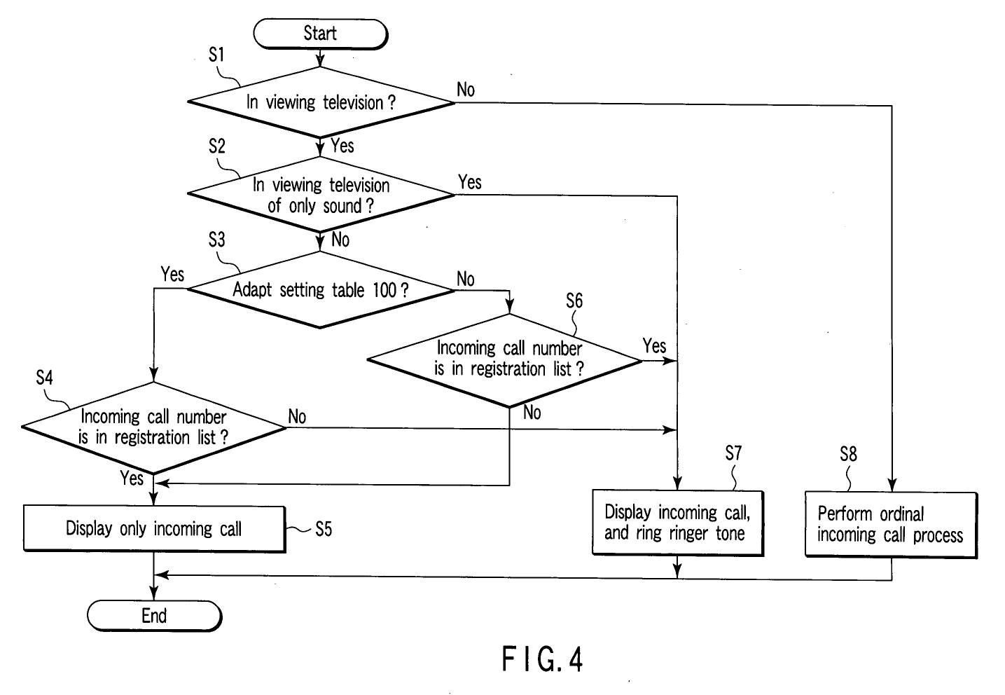

Hereinafter, an incoming call processing procedure during television viewing by the mobile-phone in FIG. 1 will be described in detail by referring to a flowchart in FIG. 4.

The case in which a voice incoming call signal is detected in television viewing will be explained as an example; however, as a matter of course, it is possible to perform a like process even when a mail receiving signal is detected. In this case, it is needed to read the ringtone as the mail receiving sound, the incoming call display as the mail receiving display, the setting table 100 as the setting table 102, and the setting table 101 as the setting table 103.

At first, when the incoming call detecting unit la detects the arrival of the incoming call, the determining unit 1e determines whether or not the mobile-phone is in television viewing (step S1). Here, when it is determined that the mobile-phone is not in the television viewing, the control unit 1 performs an ordinal incoming call process (step S8) to end this procedure in the flowchart.

On the contrary, in the step S1, when it is determined that the mobile-phone is in television viewing, the determining unit 1e further determines whether or not the mobile-phone is in viewing only for audio (step S2). That is, in the step S2, the determining unit 1e determines whether or not the mobile-phone actually outputs a video to the LCD 5. If it does not output the video to the LCD 5 (for instance, in the case that the twofold housing is closed, in the case that the mobile-phone simultaneously activates other functions to use them), the determining unit 1e determines that the mobile-phone is in television viewing only for audio. However, as mentioned above, a determination scheme is not limited to the foregoing scheme.

In the step S2, if it is determined that the mobile-phone is in television viewing only for audio, the incoming call display control unit 1b and the ringtone ringing control unit 1c performs the incoming call display on the LCD 5 and rings the ringtone from the loud-speaker 10 (step S7) to ends this procedure. On the contrary, if in the step S2, it is determined that the mobile-phone is not in television viewing only for audio, the main control unit if determines whether or not the mobile-phone adopts the table 100 which the setting not to ring, namely, to perform only the incoming call display for registered telephone numbers(step S3). In the step S3, if it is determined that the mobile-phone adopts the setting table 100, the main control unit if determines whether or not the telephone number of the incoming call has been registered in the setting table 100 (step S4). If the telephone number has been registered in the setting table 100, the incoming call display control unit 1b makes the LCD 5 perform the incoming call display, and makes the ringtone ringing control unit 1c suppress the ringing of the ringtone from the loud-speaker 10 (step S5) to end the procedure. On the contrast, if the telephone number has not been registered in the setting table 100, the incoming call display control unit 1b and the ringtone ringing control unit 1c perform to display the arrival of the incoming call on the LCD 5 and to ring the ringtone from the loud-speaker 10 (step S7) then ends the procedure of this flowchart.

In the step S3, if it is determined that the setting table 100 is not adopted, it is presumed that the setting table 101 which performing the incoming call display and also the ringing the ringtone for the registered telephone numbers is adopted. That is, the main control unit if determines whether or not the telephone number of the incoming call is registered in the setting table 101 (step S6), if it is not registered, the display control unit 1b performs the incoming call display on the LCD 5, and the ringing control unit 1c suppresses the ringing of the ringtone from the loud-speaker 10 (step S5) to end the procedure. On the contrary, if the telephone number is registered in the setting table 101, the incoming call display control unit 1b and the ringtone ringing control unit 1c perform the incoming call display by the LCD 5 and the ringing the ringtone by the loud-speaker 10, respectively (step S7) then terminates the processes in the flowchart.

According to the sequence of the processing, the determining that the user is in the television picture viewing enables displaying the incoming call information (telephone number, mail address and name, etc., of opponent party) beside the television viewing screen (at position not to overlap television content) on the LCD screen. Further, it is possible to set for suppressing the ringtone only of the specified telephone number, and inversely, for suppressing the ringtone for other than the specified telephone number. To specify the telephone number, it is also possible to directly register a telephone number, or to specify the telephone number already registered in the telephone book.

Moreover, on shifting to the speech state, in the case of using an ear microphone, etc., the user can speech while viewing the screen of the mobile-phone, so that a speech operation while viewing the television viewing screen by overlapping the television sound onto the voice of the opponent party.

As described above, the mobile-phone regarding the embodiment can avoid missing a crucial moment of an information program, sports information, etc., even if an incoming call arrives (or receives mail) during television viewing.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A mobile-phone comprising:
a receiving unit configured to receive a television broadcasting signal;
a display unit configured to display a television picture based on the television broadcasting signal and to display incoming call information showing a content of an incoming call;
a sound output unit configured to output a television sound based on the television broadcasting signal and to output a ringtone; and
a control unit configured to control the display unit to display the incoming call information at a position not to overlap with an area displaying the television picture, and to control the sound output unit to restrict the output of the ringtone, if the control unit detects a incoming call signal during displaying the television picture.

2. The mobile-phone according to claim 1, further comprising a first storage unit configured to store a first table with telephone numbers; and wherein
the control unit is configured to refer the first table if the control unit is detects the incoming call signal during displaying the television picture, and to control the sound output unit to restrict the output of the ringtone if a telephone number which the incoming call signal includes is registered in the first table.

3. The mobile-phone according to claim 1, further comprising a second storage unit configured to store a second table with telephone numbers; and wherein
the control unit is configured to refer the second table if the control unit detects the incoming call signal during displaying the television picture, and to control the sound output unit to output the ringtone if a telephone number which the incoming call signal includes is registered in the second table.

4. The mobile-phone according to claim 3, wherein the control unit is configured to refer the second table if the control unit detects the incoming call signal during displaying the television picture, and to control the sound output unit to restrict the output of the ringtone if a telephone number which the incoming call signal includes is not registered in the second table.

5. The mobile-phone according to claim 1, wherein the control unit is configured to control the display unit to display the incoming call information and to control the sound output unit to output the ringtone, if the control unit detects the incoming call signal, if the television picture is not displayed and if the television sound is output.

6. The mobile-phone according to claim 1, wherein the control unit is configured to control the sound output to overlap the television sound on a speech voice to output it when making a speech during outputting the television sound.

7. A mobile-phone comprising:
a receiving unit configured to receive a television broadcasting signal;
a display unit configured to display a television sound based on the television broadcasting signal and to display received mail information;
a sound output unit configured to output a television sound based on the television broadcasting signal and to output a mail receiving sound; and
a control unit configured to control the display unit to display the received mail information at a position not overlapping with an area displaying the television picture and to control the sound output unit to restrict the output of the mail receiving sound if the control unit detects a mail receiving signal during displaying the television picture.

8. A mobile-phone comprising:
a receiving unit configured to receive a broadcasting signal;
a display unit configured to display a picture based on the broadcasting signal and to display an incoming call information showing a content of an incoming call;
a sound output unit configured to output a sound based on the broadcasting signal and to output a ringtone; and
a control unit configured to control the display unit to display the incoming call information at a position not to overlap with an area displaying the picture, and to control the sound output unit to restrict the output of the ringtone, if the control unit detects a incoming call signal during displaying the picture.

9. The mobile-phone according to claim 7, further comprising a third storage unit configured to store a third table with mail addresses; and wherein
the control unit is configured to refer the third table if the control unit detects the mail receiving signal during displaying the television picture, and to control the sound output unit to restrict the output of the mail receiving sound when a mail address of a transmitting origin is registered in the third table.

10. The mobile-phone according to claim 7, further comprising a fourth storage unit configured to store a fourth table with mail addresses; and wherein
the control unit is configured to refer the fourth table if the control unit detects the mail receiving signal during display the television picture, and to control the sound output unit to output the mail receiving sound when a mail address of a transmitting origin is registered in the fourth table.

11. The mobile-phone according to claim 7, wherein the control unit is configured to refer the fourth table if the control unit detects the mail receiving signal during displaying the television picture, and to control the sound output unit to restrict the output of the mail receiving sound when a mail address of a transmitting origin is not registered in the fourth table.

12. The mobile-phone according to claim 7, wherein the control unit is configured to control the display unit to display the received mail information and to control the sound output unit to output the mail receiving sound if the control unit detects the mail receiving signal, if the television picture is not displayed, and if the television sound is output.
